(19) United States
(12) Patent Application Publication
(10) Pub. No.: US 2014/0058834 A1
(43) Pub. Date: Feb. 27, 2014

(54) PROVIDING TARGETED OFFERS ON FINANCIAL TRANSACTION RECEIPTS

(71) Applicants: Michael A. Liberty, Windermere, FL (US); Steve Bacastow, Cumming, GA (US)

(72) Inventors: Michael A. Liberty, Windermere, FL (US); Steve Bacastow, Cumming, GA (US)

(21) Appl. No.: 13/974,351

(22) Filed: Aug. 23, 2013

Related U.S. Application Data
(60) Provisional application No. 61/812,079, filed on Apr. 15, 2013.
(60) Provisional application No. 61/704,331, filed on Sep. 21, 2012.
(60) Provisional application No. 61/693,049, filed on Aug. 24, 2012.

(51) Int. Cl. G06Q 30/02

(52) U.S. Cl. CPC G06Q 30/0225
USPC 705/14.49; 705/14.26; 705/14.65; 705/65

(57) ABSTRACT

Embodiments are directed to aggregating product savings into a quick response (QR) code and to providing a targeted offer via a financial transaction receipt. In one scenario, a computer system scans various items that are provided for sale by a retailer. The scanning resulting in scanning information that corresponds to the scanned items. The computer system sends the scanning information for the scanned items to a second computer system to determine whether coupons or price discounts apply to the scanned items. The computer system then receives coupons or price discounts for the scanned items from the second computer system and aggregates each of the received coupons or price discounts into a QR code that is presentable by a customer at a point of sale to redeem the coupon or price discount for the scanned items.

### CROSS REFERENCE TO RELATED APPLICATIONS

This application is a continuation of and claims priority to and the benefit of U.S. Provisional Application Ser. No. 61/812,059, entitled “Providing Targeted Offers on Financial Transaction Receipts”, filed on Apr. 15, 2013. This application is also a continuation of and claims priority to and the benefit of U.S. Provisional Application Ser. No. 61/704,331, entitled “Aggregated Savings QR Code Generation and Implementation”, filed on Sep. 21, 2012. This application is further a continuation of and claims priority to and the benefit of U.S. Provisional Application Ser. No. 61/693,049, entitled “Aggregated Savings QR Code Generation and Implementation”, filed on Aug. 24, 2012. Each of these applications is incorporated by reference herein in its entirety.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email. Today's smart phones use software applications to perform a wide variety of functionality. In some cases, this functionality may include the ability to pay for items using a mobile payment system. Such a mobile payment system may allow users to pay for items at a store or over the internet using their phone.

### BRIEF SUMMARY

Embodiments described herein are directed to aggregating product savings into a quick response (QR) code and to providing a targeted offer via a financial transaction receipt. In one embodiment, a computer system scans various items that are provided for sale by a retailer. The scanning resulting in scanning information that corresponds to the scanned items. The computer system sends the scanning information for the scanned items to a second computer system to determine whether coupons or price discounts apply to the scanned items. The computer system then receives coupons or price discounts for the scanned items from the second computer system and aggregates each of the received coupons or price discounts into a QR code that is presentable by a customer at a point of sale to redeem the coupon or price discount for the scanned items.

In another embodiment, a computer system provides a targeted offer via a financial transaction receipt. The computer system receives an indication that a user has initiated a financial transaction, where the indication includes identification information corresponding to the user. The computer system then identifies the user using the received identification information, processes the financial transaction initiated by the user using a stored value account associated with the user, and provides a receipt for the transaction, where the receipt includes at least one targeted offer that is specifically selected for the user based on the user's identification information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer platform architecture for providing mobile wallet and payment processing services.

FIG. 2 illustrates an example flowchart of a customer scanning items, receiving discounts, and redeeming those discounts during the purchase of items.

FIG. 3 illustrates an embodiment of a computer system that is capable of scanning items, receiving discounts, and generating QR codes.

FIG. 4 illustrates an embodiment in which a targeted offer is provided via a financial transaction receipt.

FIG. 5 illustrates an electronic receipt with a targeted offer QR code.

FIG. 6 illustrates a printed receipt with a targeted offer QR code.

FIG. 7 illustrates a flowchart of an example method for aggregating product savings into a QR code.

FIG. 8 illustrates a flowchart of an example method for providing a targeted offer via a financial transaction receipt.

### DETAILED DESCRIPTION

Embodiments described herein are directed to aggregating product savings into a quick response (QR) code and to providing a targeted offer via a financial transaction receipt. In one embodiment, a computer system scans various items that are provided for sale by a retailer. The scanning resulting in scanning information that corresponds to the scanned items. The computer system sends the scanning information for the scanned items to a second computer system to determine whether coupons or price discounts apply to the scanned items. The computer system then receives coupons or price discounts for the scanned items from the second computer system and aggregates each of the received coupons or price discounts into a QR code that is presentable by a customer at a point of sale to redeem the coupon or price discount for the scanned items.

In another embodiment, a computer system provides a targeted offer via a financial transaction receipt. The computer system receives an indication that a user has initiated a financial transaction, where the indication includes identification information corresponding to the user. The computer system then identifies the user using the received identification information, processes the financial transaction initiated by the user using a stored value account associated with the user, and provides a receipt for the transaction, where the receipt includes at least one targeted offer that is specifically selected for the user based on the user's identification information.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the functionality disclosed herein.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

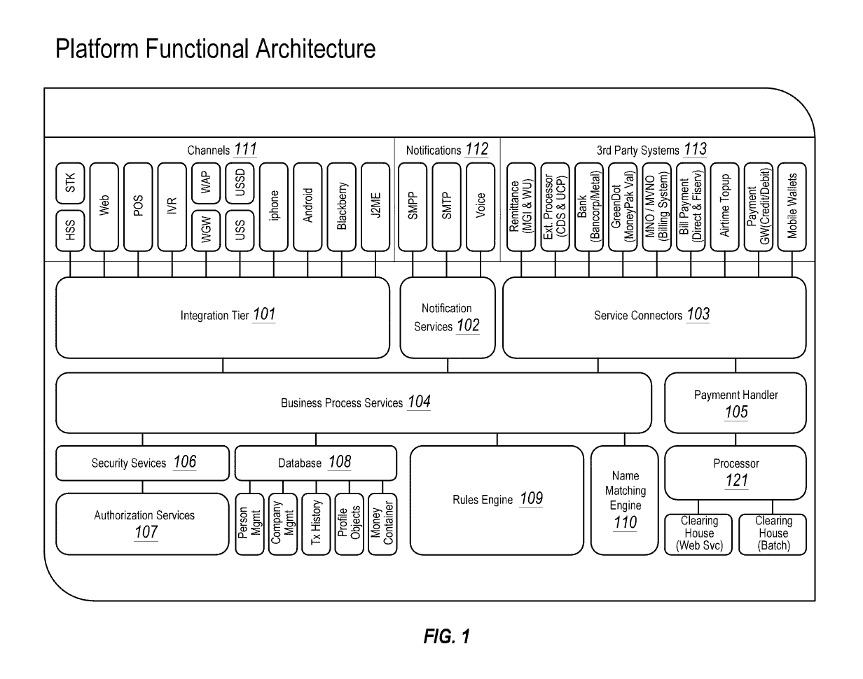

FIG. 1 illustrates an example system architecture for a mobile wallet platform. Integration tier 101 is configured to manage mobile wallet sessions and maintain integrity of financial transactions. Integration tier 101 can also include a communication (e.g., Web services) API and/or other communication mechanisms to accept messages from channels 111. Other mechanisms include, but are not limited to: International Standards Organization (“ISO”) 8583 for Point of Sale (“POS”) and Automated Teller Machines (“ATM”) devices and Advanced Message Queuing Protocol (“AMQP”) for queue based interfaces. Each of channels 111 can be integrated to one or more mechanisms for sending messages to integration tier 101. Notification services 102 is configured to send various notifications through different notification channels 112, such as, for example, Short Message Peer-to-Peer (“SSMP”) for Short Messaging Service (“SMS”) and Simple Mail Transfer Protocol (“SMTP”) for emails. Notification services 102 can be configured through a web services API.

Service connectors 103 are a set of connectors configure to connect to 3rd party systems 113. Each connector can be a separate module intended to integrate an external service to the system architecture. Business process services 104 are configured to implement business workflows, including executing financial transactions, auditing financial transactions, invoking third-party services, handling errors, and logging platform objects. Payment handler 105 is configured to wrap APIs of different payment processors, such as, for example, banking accounts, credit/debit cards or processor 121. Payment handler 105 exposes a common API to facilitate interactions with many different kinds of payment processors.

Security services 106 are configured to perform subscriber authentication. Authorization services 107 are configured to perform client authorization, such as, for example, using a database-based Access Control List (“ACL”) table.

Database 108 is configured to manage customer accounts (e.g., storing customer accounts and properties), manage company accounts (e.g., storing company accounts and properties), manage transaction histories (e.g., storing financial transaction details), store customer profiles, storing dictionaries used by the mobile wallet platform, such as, for example, countries, currencies, etc., and managing money containers. Rules engine 109 is configured to gather financial transaction statistics and uses the statistics to provide transaction properties, such as, for example, fees and bonuses. Rules engine 109 is also configured to enforce business constraints, such as, for example, transactions and platform license constraints.

Name matching engine 110 is configured to match different objects according to specified configuration rules. Matching engine 110 can be used to find similarities between names, addresses, etc. Transaction processor 121 is configured to manage financial accounts and transactions. The transaction processor 121 can be used to hold, load, withdraw and deposit funds to mobile wallet accounts. Transaction processor 121 can also be used as a common interface to a third party processor system. When used as a common interface, financial operations may be delegated to the external processor. A Clearing House subsystem of transaction processor 121 can be used to exchange the financial information with a bank.

Components of a mobile wallet platform can be connected to one another over (or be part of) a system bus and/or a network. Networks can include a Local Area Network (“LAN”), a Wide Area Network (“WAN”), and even the Internet. Accordingly, components of the mobile wallet platform can be “in the cloud”. As such, mobile wallet platform components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the system bus and/or network.

The components depicted in FIG. 1 can interoperate to provide a number of financial and other services including but not limited to enrolling a customer for a mobile wallet, adding a stored value account (either hosted by a mobile wallet platform or a third party), adding a bank or credit union account to a mobile wallet, adding a debit or credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet (nationally or internationally), making in-store purchases using a mobile wallet, and various other tasks as described herein below.

The telephone, smart phone, tablet or other computing system that interacts with the mobile payment system typically includes a camera, image sensor, image scanner or other hardware that allows a user to scan or capture an image. The user may thus point the camera or other hardware at an object such as a can of soup and either take a picture of the object, or allow software to scan the image. Using the image scan or picture, software on the phone or tablet performs a search or consults a database to retrieve information related to that item or product including coupons or price discounts. These discounts may be saved on the user's smart phone or tablet and may be applied to a quick response (QR) code. This QR code may then be used when checking out and paying for the items.

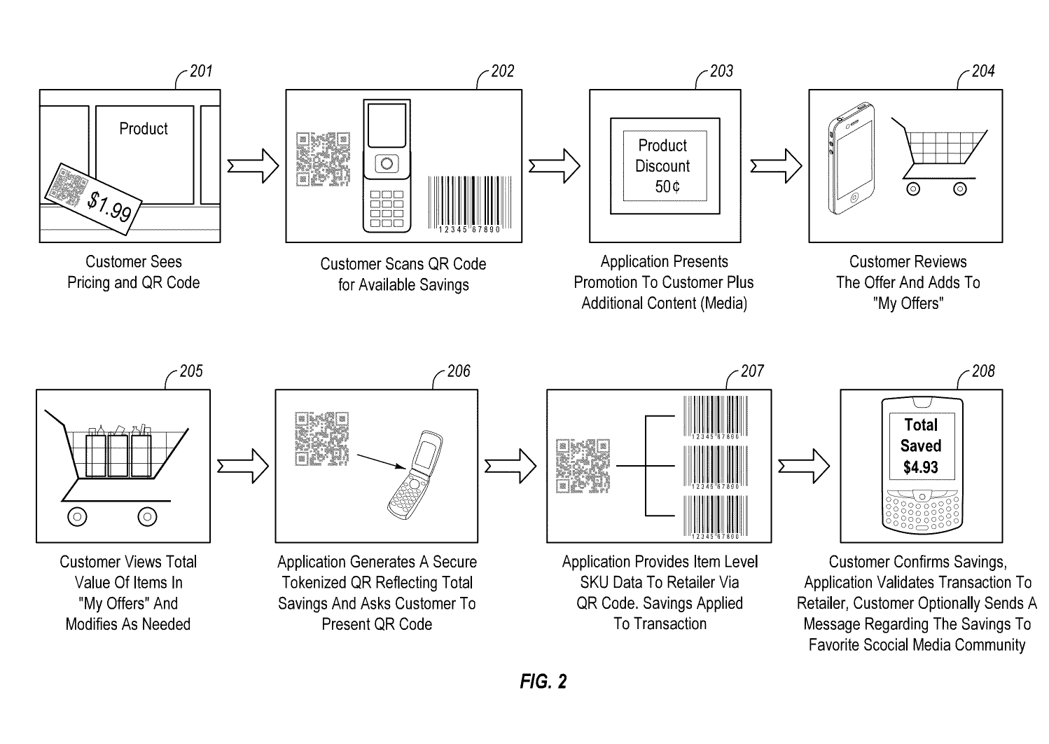

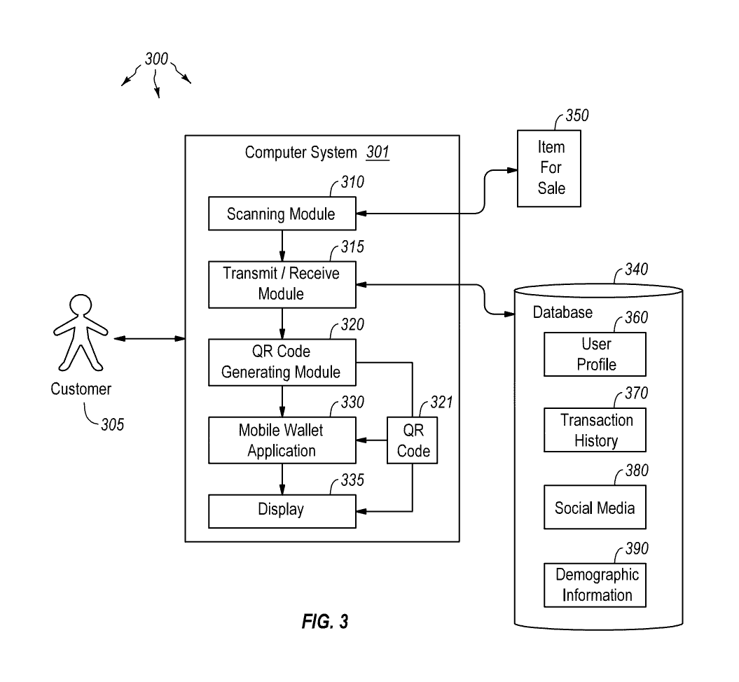

For instance, in one embodiment shown in FIGS. 2 and 3, a customer may be at a store shopping for items (e.g. item 350 of environment 300 in FIG. 3). The user 305 may find an item (in step 201 of FIG. 2) and scan the item (in step 202) by taking an image of the item or scanning the item (or its barcode or corresponding QR code (e.g. 310 of FIG. 3)) with scanning module 310 (e.g. a cell phone camera). Information from the scan may be sent using transmit/receive module 315 to a second computer system such as database 340. The database may be accessible via the internet over a cellular, WIFI or other connection. The database 340 may include information corresponding to the product 350 that is linked to the product's bar code or QR code. The information may include information about the item itself (including nutrition information, serving sizes, etc.) or related information such as advertisements, coupons or other discounts or promotions.

The database or other computer system determines which information is relevant based on any combination of the user's profile 360 information stored in the database 340, purchase transaction history 370 social media information 380, and/or demographic information 390, and returns that information to the user's mobile device 301. (While shown as being stored in database 340, it will be understood that any of elements 360, 370, 380 and 390 may be stored in and/or received from other locations, such as from a user's cell phone). The mobile wallet application mentioned above (element 330 of FIG. 3), or another software application, may present the promotions and other discounts to the user (as shown in step 203), along with product information and related media. Such media may include downloadable recipes, website links or videos showing food preparation). The user may review the product information and/or price discounts via the mobile wallet 330 or via another application running on the mobile device 301. If the user sees a coupon or promotion that they want to keep, they can add that coupon to a “My Offers” folder (as shown in step 204) or other data store where the coupon and its corresponding product information (including bar code and/or stock-keeping unit (SKU)) may be stored. In this manner, the customer 305 may scan and store coupons or other price discounts for as many items as they desire.

Once the customer is ready for checkout, the coupons and discounts stored in the “My Offers” folder may be shown to the user (in step 205) on display 335 so that the user can review them and modify them as necessary. For instance, the user may no longer desire to purchase one of the items they have scanned and, as such, may delete the information and/or discounts related to that item. The QR code generating module 320 of the mobile wallet application or other application on the user's phone or tablet 301 may be used to generate a QR code 321 that includes or represents the coupons and discounts for each of the scanned items. The QR code is a secure, tokenized code (as shown in step 206) that reflects the total savings from the discounts of each of the scanned items. Thus, a single generated QR code includes (or has encoded in it) the product information and corresponding discount information for each of the user's scanned items.

Once the user (or a retail worker) has scanned each of the items for payment at the checkout register, the user may present the generated QR code at the point of sale. Once scanned, the QR code will indicate to the retailer (at 207) each of the items the user is purchasing, along with the items' bar codes, SKUs and other information used by the retailer for inventory or checkout purposes. The retailer's point of sale system applies the discounts to each of the items 350 scanned by the user. The user verifies that the discounts were applied at 208 and pays for the items using the mobile wallet application 330 or some other traditional form of payment such as cash, check or credit card.

Thus, a user may scan and receive coupons, price matches or other discounts for multiple different items. Each of these may be stored in the user's phone. A QR code may be generated that represents each of the coupons or other discounts. Then, upon checking out, the user may scan the QR code and receive a corresponding price reduction for each of the items for which the user has a coupon. The coupons are applied automatically and electronically for each of the items, while only having to scan one QR code. If the user had coupons and/or price discounts for, say, ten different items, the QR code would include the SKUs and corresponding discounts for all ten items. The QR code may also include other discounts or promotional items such as retailer or brand loyalty points or other in-store offers. The discounts are applied to the user's total substantially instantaneously. Once the user confirms that the discounts have been applied, and that the total has been appropriately reduced, the customer can pay for the items. The user may also choose to publish information related to the transaction to a social media community using their phone. Such information may indicate the amount of money the user has saved using the QR code, or may indicate that the user likes a particular retailer.

Accordingly, methods, systems and computer program products are provided which aggregate product savings into a quick response (QR) code. Embodiments allow users to scan an item that a retailer is selling, and receive coupons or other discounts for that item. These discounts are rolled into a QR code that is dynamically generated for those items. The QR code is then scanned, and each item's corresponding discount is applied automatically at checkout. Once the discounts have been applied, the user can pay for the items using his or her mobile wallet.

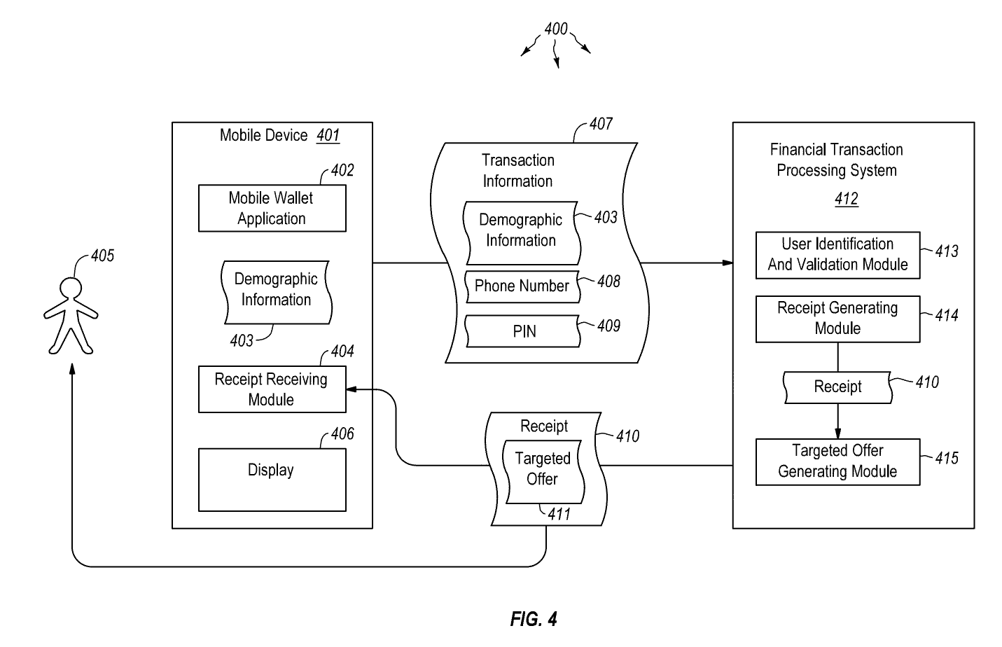

Turning now to FIG. 4, other embodiments will be described in which targeted offers may be provided via financial transaction receipts. As shown in FIG. 4, a mobile device 401 may be provided. Mobile device 401 may be any type of computer system, including a cellular phone, tablet, laptop, gaming device or other mobile computing system. The mobile device includes various modules for performing different functionality. For instance, mobile device 401 may include a mobile wallet application 402. The mobile wallet application may provide many different types of functionality, including the ability to pay for goods and services using the mobile device 401. The mobile wallet may be linked to various credit and/or debit accounts belonging to the user 405. The mobile wallet may then facilitate initiation and completion of a financial transaction, in conjunction with a financial transaction processing system 412.

The financial transaction processing system 412 may be configured to receive transaction information 407 for one or more different financial transactions initiated by different native or third party mobile wallet applications. In one example, user 405 may use mobile wallet application 402 on mobile device 401 to initiate a financial transaction at a retailer that allows items to be paid for using a mobile wallet. The mobile wallet application 402 may send transaction information 407 including the user's name and other demographic information 403, bank and/or credit card information, the user's phone number 408 and the user's personal identification number (PIN) 409. The transaction information 406 may include other information used to process the transaction including the items or services being purchased, pricing information, tax information and other related items.

The user identification and validation module 413 of the financial transaction processing system 412 may receive and process the transaction information. The user identification and validation module 413 may use the received demographic information 403, phone number 408 and/or PIN 409 to identify the user 405 and verify the user's identity. In some embodiments, the financial transaction processing system may generate a perishable, encrypted validation token (not shown) that is to be used by the user and/or the mobile wallet application 402 to complete the transaction. A validation token may refer to a software, hardware or other security token that may be used to validate a transaction. In some embodiments, the validation token may be an encrypted software token that facilitates two-factor authentication. The validation token may be generated based on a shared secret or based on public key (i.e. asymmetric) cryptography. Regardless of how the perishable, encrypted validation token is generated or which kind of token is generated, the token may be sent to the mobile device 401 to validate the financial transaction.

After the transaction has been processed by the financial transaction processing system 412, the receipt generating module 414 may generate a receipt 410. The receipt may include transaction information including the date, time, amount, account used for payment and other related information. Before the receipt 410 is sent, however, the targeted offer generating module 415 in the financial transaction processing system 412 may append a targeted offer 411 to the receipt 410. The receipt may be an electronic receipt or a physical (e.g. paper) receipt.

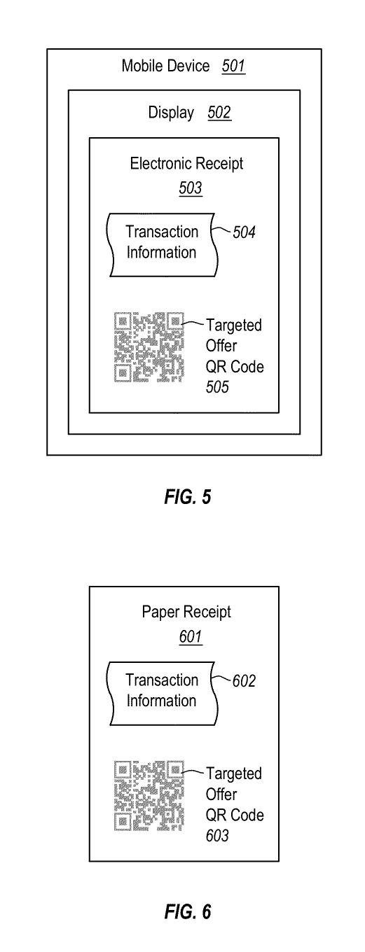

For example, as shown in FIG. 5, the receipt may be an electronic receipt 503 which is transmitted to the mobile device 501 and displayed on the device's display 502. The electronic receipt includes related transaction information 504, as well as the targeted offer. The offer may be a plain text voucher, coupon or other offer, and may be stored in a data store in the mobile device or in the mobile wallet application 402. Alternatively, the offer may be in the form of a QR code that may be scanned and/or interpreted by the mobile wallet (or another mobile device application). The QR code may include or link to information about the targeted offer. Similarly, in FIG. 6, a paper receipt 601 may be provided that includes related transaction information 602 and a targeted offer. The (electronic or paper) receipt may be sent in response to substantially any financial transaction, including when paying for goods or services, when selling goods or services, when transmitting money to other users or locations, when retrieving money from an automated teller machine (ATM).

The targeted offer may originate from substantially any producer or seller of goods or services. The targeted offer may be shown to the user 405 when the receipt is received by the receipt receiving module 404. Thus, when the user is using the mobile wallet to pay for an item, transfer money or perform some other financial transaction, the receipt resulting from the transaction may include a targeted offer from a company. The offer may be the same for a given period of time, or may change each transaction. The targeted offer 411 may be a coupon or voucher, or may be a QR code with embedded information about the offer.

The targeted offer 411 may be targeted to the user 405 based on the demographic information 403 sent with the transaction information 407. The demographic information may be detailed or general in nature, depending on the transaction, the offer-providing company, agreements between the user 405 and the financial transaction processing system 412, or other settings or regulations. Thus, for example, the targeted offer generating module 415 may look at the demographic information 403 for user 405 and determine that the user is a male between 25-35, is of Hispanic descent, is college educated and lives within one mile of the store at which the financial transaction is taking place. The targeted offer generating module 415 may then generate and append an offer that is targeted to his demographic. Similarly, the financial transaction system 412 may determine that the user is a female between the ages of 50-60 and has a yearly income of between $35-$50,000. The targeted offer generating module 415 may then append an offer that is targeted to her demographic.

In this manner, producers and sellers of goods and services may market their items to users of a certain demographic. While two examples are given above, it will be appreciated that substantially any type of demographic information may be queried of the mobile device user and stored in the demographic information 403. Moreover, it will be appreciated that certain offers will be more applicable to certain groups of people, whether it be young males or females, mothers or fathers, the elderly, certain ethnicities, religious groups, education levels, income levels, location of residence or other demographics. Accordingly, a producer or seller may specify which offers are to be presented to which mobile wallet users.

The offers may be further targeted based on the location where the financial transaction is taking place. For instance, if the user 405 initiates a transaction at an ATM within a specified grocery store, the targeted offer may be for goods or services provided by that grocery store. Similarly, the offer may be for goods or services provided by other retailers within a certain range of the store (e.g. other stores within a mall or shopping area). The targeted offers 411 may be placed above, below, on the sides or substantially anywhere within the receipt 410.

In one embodiment, the financial transaction processing system 412 receives an indication 407 that a mobile wallet user 405 has initiated a financial transaction. The indication includes various portions of identification information (e.g. phone number 408 and/or PIN 409) for the mobile wallet user. The financial transaction processing system 412 identifies the mobile wallet user using the received identification information. Once the user has been identified, the financial transaction processing system 412 processes the financial transaction initiated by the mobile wallet user using at least one stored value account associated with the mobile wallet user. This account could be a bank account, a credit card account, a prepaid debit card or other value store. The receipt generating module 414 of the financial transaction processing system 412 may then generate a receipt for the transaction where the receipt includes a targeted offer that is specifically selected for the mobile wallet user based on the user's identification information. It should be appreciated that the targeted offer may also be presented by the user during a store check out process to facilitate immediate redemption. In this case the offer may be presented as one of many aggregated offers, as previously described in FIG. 3.

As mentioned above, the demographic information 403 associated with the mobile wallet user sent along with the transaction information 407 may be accessed by the financial transaction processing system 412. The demographic information 403 is used to target the offer to the mobile wallet user 405. Retailers and producers that create the offers and want to disseminate their offers may be provided with at least a portion of the user's demographic information. In some cases, the information may be quite limited, while in other cases, a larger amount of demographic information 403 may be provided. The offer may be for goods or services that would likely interest the user 405, or may be for goods or services provided within a close radius of the user's current location. For example, if the user is at a retail store buying goods, the targeted offer may be for a local restaurant that is in the retail store's vicinity. Many other such embodiments are possible, including providing offers for certain types of stores, certain types of services, stores within a specified driving or walking distance, stores that are currently open (e.g. if the transaction is being performed late at night), stores that cater to that user's demographic, or other scenarios.

In some cases, if the financial transaction is initiated within a specified store, the targeted offer may be valid for items sold by the specified store (or group of stores, or stores owned by the same owner). The targeted offer may include a voucher or coupon that expires after a specified period of time, or is only valid on certain days or at certain times. In some cases, the retailer or goods producer that is providing offer may receive an indication that the targeted offer was viewed and/or stored by the mobile wallet user, thereby establishing that the offer reached the user. The user may store many such targeted offers in their mobile wallet.

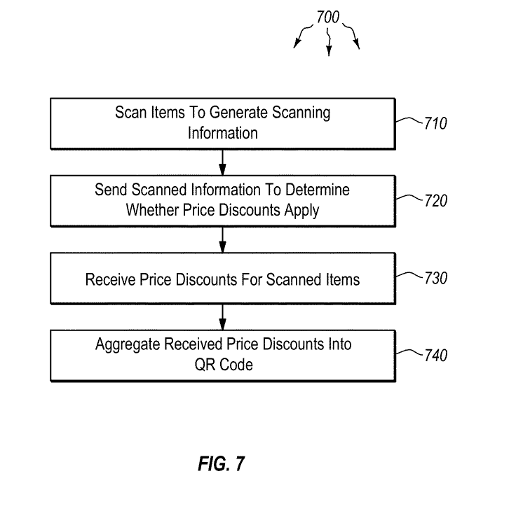

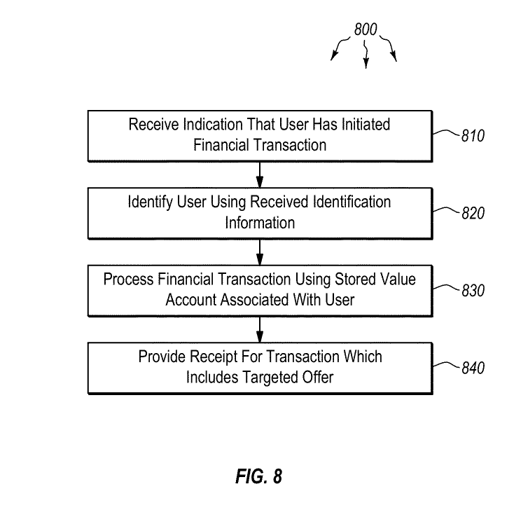

In some embodiments, the user may be able to search through their stored offers, which may be organized according to product, stores at which the offer is valid, by date of expiration, or by some other manner. The offers may include free samples, buy-one-get-one-free offers, coupons or other offers. The user may then redeem these offers to receive their free or reduced-cost items. After the offer has been redeemed, the offer provider may be notified (electronically or otherwise) that the offer was redeemed, and may be further notified of the user's demographics that redeemed the offer. In this manner, producers or sellers of goods and services may be able to offer savings or free trial products to target audiences via electronic or paper transaction receipts. These concepts will be explained further below with regard to methods 700 and 800 of FIGS. 7 and 8, respectively.

In view of the systems and architectures described above, methodologies that may be implemented in accordance with the disclosed subject matter will be better appreciated with reference to the flow charts of FIGS. 7 and 8. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 7 illustrates a flowchart of a method 700 for aggregating product savings into a quick response (QR) code. The method 700 will now be described with frequent reference to the components and data of environments 300 and 400 of FIGS. 3 and 4, respectively.

The scanning module 310 of computer system 301 may be configured to scan items 350 that are provided for sale by a retailer (710). This scanning results in scanning information that is related to the items scanned (e.g. bar codes, QR codes, stock keeping unit numbers (SKUs), or other information). This scanning information may be transmitted (e.g. by module 315) to a database 340 or to another computer system (720). This database or second computer system may then determine whether coupons or price discounts apply to the scanned items 350. The database may, for example, include coupons for certain brands of soup or cold cereal. If the user 305 scans one of those brands of soup or cereal, the user may be notified that a coupon exists and has been sent to their mobile device 301. In some cases, coupons or other discounts (such as vouchers for a free product) may be generated specifically for those customers that scan the items. For instance, scanning a QR code on a bag of chips may provide a special offer for those chips to the customer. Scanning the QR code may, at least in some cases, automatically initiate a transmission of data from the second computer system to the mobile computer system 301. In such cases, the user would only need to scan the item to initiate the search for discounts. The discount may be the same for each person that scans the item, or it may be different for certain customers or certain types of customers (e.g. certain demographics, or certain purchasing history, etc.).

After the scanned information has been sent to the database 340 or second computer system, the mobile computer system 301 may receive coupons or price discounts for the scanned items from the second computer system (730). These coupons may be provided by the distributor or producer of the goods. As such, the producer may be able to directly target or provide discounts to customers that are (immediately) interested in purchasing their products. These coupons may further provide loyalty points for purchasing a certain brand, or may provide discounts for other products also produced by that goods provider. Each of the received discounts and offers may be aggregated into a QR code 321 that is presentable by the customer 305 at a point of sale to redeem the coupon or price discount for the scanned items (740). Accordingly, as the user pays for the items, the user may scan the generated QR code 321 at the point of sale, and all of the aggregated price discounts will be applied to the purchase of the items. The QR code includes the price discounts in information embedded therein. Thus, when the QR code is scanned at the point of sale, the price discount information is automatically transferred to the retailer. In cases where the user pays for the items with a mobile wallet, the discounts may be applied automatically.

In some embodiments, when the QR code 321 is presented at the point of sale during checkout, the QR code may provide an identifier for each item and corresponding coupon or price discount. Thus, the QR code may embed information such as each item's SKU or other identification information. Once the coupons or price discounts have been properly applied to the items, the customer may pay for the scanned items as they normally would, using cash, credit cards, debit cards. In some cases, as mentioned above, a mobile wallet application running on a mobile phone (e.g. 301) may be used to pay for the items. The mobile wallet is linked to a stored value account associated with the user. The mobile wallet may allow the user to select which debit, credit or other linked account may be used to pay for the items.

The mobile wallet application may further be configured to allow the customer to publish information related to the transaction to a social media web site. For instance, the mobile wallet application (or another application running on the mobile phone) may send a text message to a certain group of users (or to the public at large), or may post on a social media timeline or other web site, indicating that the user received a (large) discount on a certain product or products, and that other users can receive the same discounts by scanning the item's QR code or bar code and/or using the mobile wallet application. In some cases, the user that posted to social media may receive additional discounts for their efforts. Customers that receive coupons and other price discounts may review their offers to determine whether to keep the discounts. The discounts may be stored automatically, and then discarded by the user if undesired. If the discounts are not used for a specified period of time, or if the discounts expire, they may be automatically discarded. In this manner, a retailer or a provider of goods may provide targeted discounts to users that are interested in their product.

While coupons and discounts have been described in the context of a grocery store above, it will be understood that the above-described method may apply to retailers of clothing, home furnishings, jewelry, etc., to providers of entertainment items or events (e.g. movie or event tickets), services (e.g. manicures, lawn maintenance services, etc.) or any other type of goods or services.

FIG. 8 illustrates a flowchart of a method 800 for providing a targeted offer via a financial transaction receipt. The method 800 will now be described with frequent reference to the components and data of environment 300 and 400 of FIGS. 3 and 4, respectively.

Method 800 includes receiving an indication that a user has initiated a financial transaction, wherein the indication includes identification information corresponding to the user (810). The identification information may include the user's name, phone number, account number, PIN number or other identifiers. The identification may be received from a user, from a point of sale (e.g. in a store) or from another location such as from an automated teller machine (ATM). For instance, a user may use an ATM at a mall or other location and receive a targeted offers for goods or services at nearby stores (e.g. stores in that mall or shopping area, or stores within a specified distance from the ATM's location. The offers may include coupons, vouchers or other discounts valid for goods or services provided by one or more businesses within a specified distance from the ATM's location. The coupon or discount provider may, at least in some cases, receive an indication that the coupon or voucher was redeemed at one of the businesses within the specified distance from the ATM's location.

Returning to Method 800, upon receiving the identification information, the computer system processing the payment identifies the user using the received identification information (820). It then processes the financial transaction initiated by the user using at least one stored value account associated with the user (830) (as indicated, for example, by a mobile wallet application running on the user's cell phone). The computer system may then provide a receipt for the transaction, where the receipt includes at least one targeted offer that is specifically selected for the user based on at least a portion of the user's identification information (840).

As shown in FIG. 5, the receipt may be an electronic receipt 503 that includes the corresponding transaction information 504 and a targeted offer QR code 505. This electronic receipt may be provided via a mobile wallet or other application on the user's cell phone, tablet or other mobile computer system. The QR code 505 includes the discount or other offer embedded therein. In another embodiment, as shown in FIG. 6, the targeted offer QR code 603 may be provided on a paper receipt 601 (along with transaction information 602). The paper receipt may include a scannable QR code or a bar code or some other scannable code capable of including embedded information (or linking thereto). As with the example above, whether the QR code is included on a paper receipt or an electronic receipt, the provider of the discount (e.g. the goods producer) may be sent an indication that the targeted offer was redeemed by the user. Still further, at least in some embodiments, a perishable, encrypted token may be generated that is to be used in the financial transaction initiated by the user. This perishable, encrypted token may be sent to the user to validate the financial transaction. This token may be received and processed by the mobile wallet application or by another application running on the user's mobile device.

Accordingly, methods, systems and computer program products are provided which aggregate offers into QR codes, and which provide targeted offers via financial transaction receipts. It should be understood that the financial transactions references above may be compliant with any of a plurality of country-specific regulations including at least Know Your Customer (KYC) regulations, the PATRIOT Act and the Payment Card Industry Data Security Standard (PCIDSS).

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

I claim:

1. A computer system comprising the following:
one or more processors;
system memory;
one or more computer-readable storage media having stored thereon computer-executable instructions that, when executed by the one or more processors, cause the computing system to perform a method for aggregating product savings into a quick response (QR) code, the method comprising the following:
scanning one or more items that are provided for sale by a retailer, the scanning resulting in one or more portions of scanning information;
sending the scanning information for the scanned items to a second computer system to determine whether coupons or price discounts apply to the scanned items;
receiving one or more coupons or price discounts for the scanned items from the second computer system; and
aggregating each of the received coupons or price discounts into a QR code that is presentable by a customer at a point of sale to redeem the coupon or price discount for the scanned items.

2. The computer system of claim 1, further comprising:
determining that each of the items for which a coupon or price discount was received has been scanned for payment at the point of sale;
presenting the QR code at the point of sale during checkout, wherein the QR code provides an identifier for each item and corresponding coupon or price discount; and
upon determining that the coupons or price discounts have been properly applied to the items, paying for the scanned items.

3. The computer system of claim 2, wherein the computer system comprises a cellular telephone.

4. The computer system of claim 3, wherein the items are paid for using a mobile wallet application on the cellular telephone.

5. The computer system of claim 1, wherein scanning the item for sale comprises scanning at least one of a bar code and a QR code for the item.

6. The computer system of claim 5, wherein scanning the QR code provides a special offer to the customer.

7. The computer system of claim 1, wherein scanning the QR code initiates a transmission of data from the second computer system to the computer system, the data transmission including one or more portions of information related to the scanned item.

8. The computer system of claim 1, wherein the customer publishes one or more portions of information related to the transaction to a social media web site using the computer system.

9. The computer system of claim 1, wherein the determination as to whether scanned items are eligible for a coupon is based on at least one of a customer profile, a transaction history, demographic information, and social media data.

10. A computer system comprising the following:
one or more processors;
system memory;
one or more computer-readable storage media having stored thereon computer-executable instructions that, when executed by the one or more processors, cause the computing system to perform a method for providing a targeted offer via a financial transaction receipt, the method comprising the following:
receiving an indication that a user has initiated a financial transaction, the indication including one or more portions of identification information corresponding to the user;
identifying the user using the received identification information;
processing the financial transaction initiated by the user using at least one stored value account associated with the user; and
providing a receipt for the transaction, the receipt including at least one targeted offer that is specifically selected for the user based on at least a portion of the user's identification information.

11. The computer system of claim 10, wherein the receipt comprises an electronic receipt provided via a mobile wallet application.

12. The computer system of claim 11, wherein the electronic receipt includes a quick response (QR) code that includes the targeted offer.

13. The computer system of claim 10, wherein the receipt comprises a paper receipt that includes at least one of a scannable QR code and a bar code.

14. The computer system of claim 10, further comprising receiving an indication that the targeted offer was redeemed by the user.

15. The computer system of claim 10, wherein the indication is received from an automated teller machine (ATM) at a specified location.

16. The computer system of claim 15, wherein the targeted offer is specific to goods or services provided by one or more points of sale within a specified distance from the ATM's location.

17. The computer system of claim 16, wherein the targeted offer comprises at least one of a coupon and a voucher valid for goods or services provided by one or more businesses within a specified distance from the ATM's location.

18. The computer system of claim 17, further comprising receiving an indication that the coupon or voucher was redeemed at one of the one or more businesses within a specified distance from the ATM's location.

19. The computer system of claim 18, wherein the identification information includes at least one of the mobile wallet user's phone number and a personal identification number (PIN).

20. The computer system of claim 10, further comprising:
generating a perishable, encrypted token that is to be used in the financial transaction initiated by the user; and
sending the perishable, encrypted token to the user to validate the financial transaction.

21. A computer system comprising the following:
one or more processors;
system memory;
one or more computer-readable storage media having stored thereon computer-executable instructions that, when executed by the one or more processors, cause the computing system to perform a method for providing a targeted offer via a financial transaction receipt, the method comprising the following:
receiving an indication that a user has initiated a financial transaction, the indication including one or more portions of identification information corresponding to the user;
identifying the user using the received identification information;
generating a perishable, encrypted token that is to be used in the financial transaction initiated by the user;
sending the perishable, encrypted token to the user;
processing the financial transaction initiated by the user using at least one stored value account associated with the user; and
providing a receipt for the transaction, the receipt including at least one targeted offer that is specifically selected for the user based on at least a portion of the user's identification information.
